(19) United States
(12) Patent Application Publication
(10) Pub. No.: US 2022/0399768 A1
(43) Pub. Date: Dec. 15, 2022

(54) ROTOR, MOTOR, PUMP, REFRIGERATION CYCLE APPARATUS, AND MANUFACTURING METHOD OF ROTOR

(71) Applicant: Mitsubishi Electric Corporation, Tokyo (JP)

(72) Inventors: Hiroki Aso, Tokyo (JP); Takanori Watanabe, Tokyo (JP); Kazuchika Tsuchida, Tokyo (JP); Takaya Shimokawa, Tokyo (JP); Ryogo Takahashi, Tokyo (JP)

(21) Appl. No.: 17/776,681

(22) PCT Filed: Jan. 24, 2020
(86) PCT No.: PCT/JP2020/002470

§ 371 Date: May 13, 2022

(51) Int. Cl. H02K 1/276; F25B 31/02; F04D 13/06; H02K 1/28; H02K 21/14; H02K 15/03

(52) U.S. Cl. CPC H02K 1/276; F25B 31/026; F04D 13/06; H02K 1/28; H02K 21/14; H02K 15/03

(57) ABSTRACT

A rotor is a rotor for a pump. The rotor includes a rotor core having a magnet insertion hole and having an annular shape about an axis, a permanent magnet inserted in the magnet insertion hole, and a rotor cover surrounding the rotor core from outside in a radial direction about the axis. The rotor core has a first core portion disposed on an inner side of the magnet insertion hole in the radial direction, a second core portion disposed on an outer side of the magnet insertion hole in the radial direction, and a hole separating the first core portion and the second core portion from each other. The rotor cover has a positioning portion that positions the first core portion and the second core portion in a circumferential direction about the axis.

This application is a U.S. national stage application of International Patent Application No. PCT/JP2020/002470 filed on Jan. 24, 2020, the disclosure of which is incorporated herein by reference.

### TECHNICAL FIELD

The present disclosure relates to a rotor, a motor, a pump, a refrigeration cycle apparatus, and a manufacturing method of a rotor.

### BACKGROUND

A rotor for a pump includes a rotor core in which a magnet insertion hole is formed. A permanent magnet is disposed in the magnet insertion hole. The rotor core is divided by the magnet insertion hole into an outer circumferential side portion and an inner circumferential side portion, and these potions are connected to each other by a bridge portion (see Patent Document 1, for example).

### PATENT REFERENCE

Patent Reference 1: Japanese Patent Application Publication No. 2016-067190 (see FIG. 6)

In the rotor provided with the bridge portion, however, it is likely that a magnetic flux exiting from the permanent magnet is not directed to a stator but returns to the same permanent magnet through the bridge portion. That is, a so-called magnetic flux leakage is likely to occur. In particular, in a motor for a pump, the outer diameter of the rotor core is relatively small because a water path is provided around the rotor. Therefore, the width of the bridge portion tends to be large relative to the outer diameter of the rotor core, and the magnetic flux leakage is likely to lead to reduction of motor efficiency.

### SUMMARY

The present disclosure is made to solve the above described problem, and an object of the present disclosure is to suppress magnetic flux leakage and improve motor efficiency.

A rotor of the present disclosure is a rotor for a pump. The rotor includes a rotor core having a magnet insertion hole and having an annular shape about an axis, a permanent magnet disposed in the magnet insertion hole, and a rotor cover surrounding the rotor core from outside in a radial direction about the axis. The rotor core has a first core portion disposed on an inner side of the magnet insertion hole in the radial direction, a second core portion disposed on an outer side of the magnet insertion hole in the radial direction, and a hole separating the first core portion and the second core portion from each other. The rotor cover has an end surface portion in contact with one end surface of the rotor core in a direction of the axis. The end surface portion has a concave portion that engages with the second core portion. The first core portion and the second core portion are positioned in a circumferential direction about the axis by engagement between the concave portion and the second core portion.

In the rotor according to the present disclosure, the first core portion and the second core portion are held by the rotor cover and are positioned in the circumferential direction by the positioning portion of the rotor cover. Therefore, the rotor can be configured so that the first core portion and the second core portion are separated from each other. This configuration can suppress a magnetic flux leakage and improve a motor efficiency.

### BRIEF DESCRIPTION OF THE DRAWINGS

FIG. 1 is an exploded perspective view showing a pump according to a first embodiment.

FIG. 2 is an exploded perspective view showing a pump portion of the pump according to the first embodiment.

FIG. 3 is a longitudinal sectional view showing the pump according to the first embodiment.

FIG. 4 is a longitudinal sectional view showing a molded stator according to the first embodiment.

FIG. 5 is a perspective view showing a stator assembly according to the first embodiment.

FIG. 6 is a perspective view showing a casing of the pump portion according to the first embodiment.

FIG. 7 is a perspective view showing a cup-shaped partitioning part according to the first embodiment.

FIG. 8 is a longitudinal sectional view showing a rotor portion according to the first embodiment.

FIG. 9 is a sectional view of the rotor portion, taken along line 9-9 in FIG. 8.

FIG. 10 is a sectional view of the rotor portion, taken along line 10-10 in FIG. 8.

FIG. 11 is a sectional view of the rotor portion, taken along line 11-11 in FIG. 8.

FIG. 12 is a flowchart showing a manufacturing process of a rotor according to the first embodiment.

FIG. 13 is a longitudinal sectional view for explaining a molding process in the manufacturing process of the rotor according to the first embodiment.

FIG. 14 is a longitudinal sectional view for explaining the molding process in the manufacturing process of the rotor according to the first embodiment.

FIG. 15 is an enlarged cross sectional view showing a portion of a rotor portion according to a second embodiment.

FIG. 16 is a longitudinal sectional view for explaining a molding process in a manufacturing process of the rotor of FIG. 15.

FIG. 17 is a cross sectional view for explaining the molding process in the manufacturing process of the rotor of FIG. 15.

FIG. 18 is an enlarged cross sectional view showing a portion of a rotor portion according to a first modification.

FIG. 19 is a cross sectional view showing a rotor portion according to a second modification.

FIG. 20 is a block diagram showing a heat pump water heater to which the pumps according to the first to third embodiments and the modifications are applicable.

FIG. 21 is a block diagram showing a refrigeration cycle apparatus to which the pumps according to the first to third embodiments and the modifications are applicable.

### DETAILED DESCRIPTION

Embodiments are described in detail below, with reference to the drawings. The present disclosure is not limited to the embodiments.

### First Embodiment

### (Pump 1)

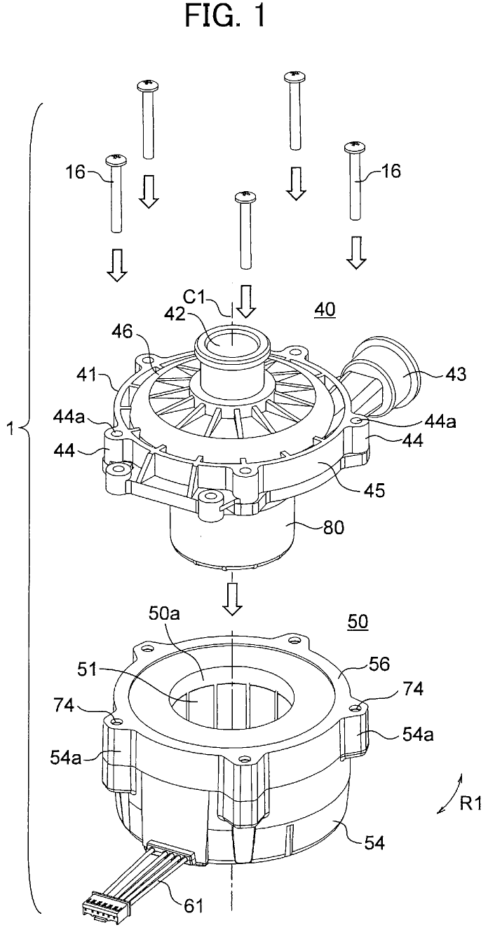

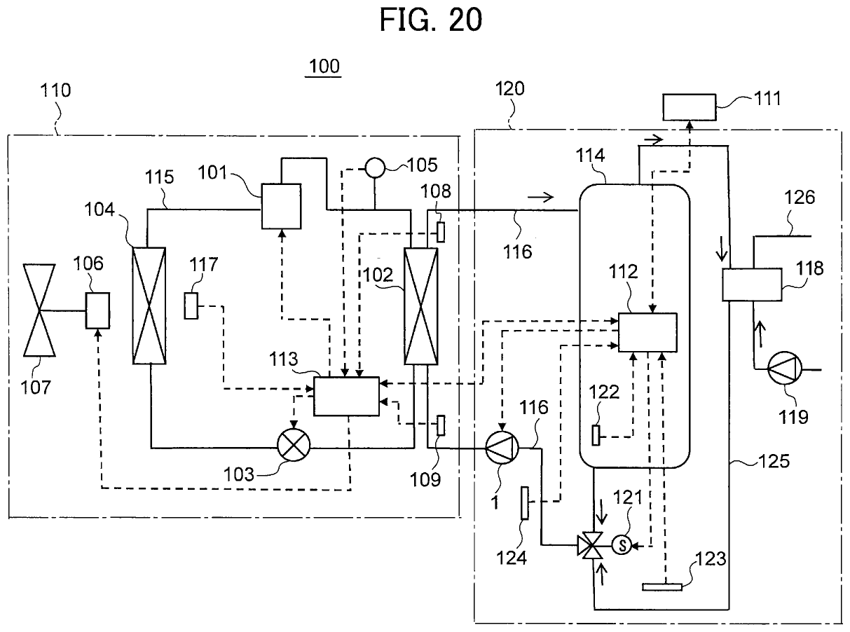

FIG. 1 is an exploded perspective view showing a pump 1 according to a first embodiment. The pump 1 according to the first embodiment is used in, for example, a tank unit 120 of a heat pump water heater 100 (FIG. 20).

The pump 1 includes a pump portion 40 and a molded stator 50. The pump portion 40 is fixed to the molded stator 50 with tapping screws 16, i.e., fastening screws. The number of tapping screws 16 is five in FIG. 1, but is not limited to five.

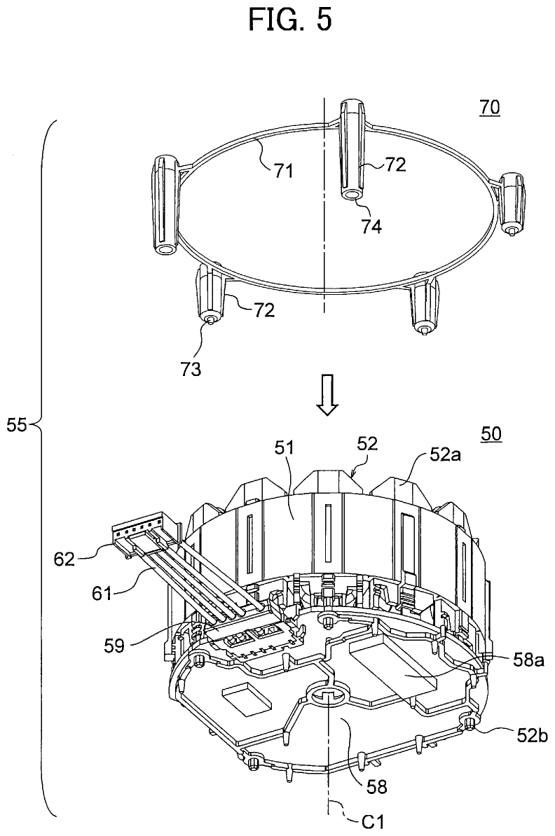

Boss portions 44 each having a through hole 44a are formed in an outer circumferential portion of the pump portion 40. Each through hole 44a allows the tapping screw 16 to be inserted therethrough. The pump portion 40 is fixed to the molded stator 50 by screwing the tapping screws 16 penetrating through the through holes 44a, into pilot holes 74 of a pilot hole part 70 (FIG. 5) embedded in the molded stator 50.

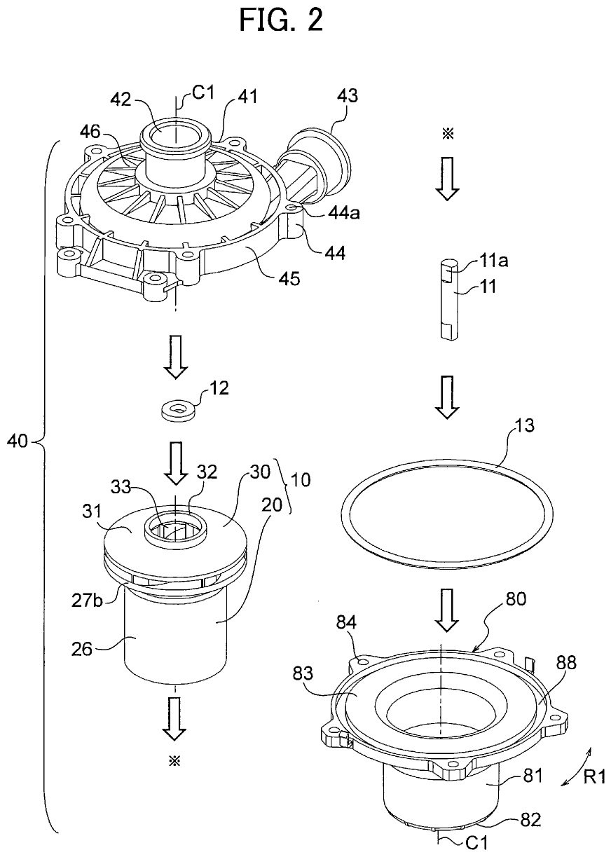

FIG. 2 is an exploded perspective view showing the pump portion 40. As shown in FIG. 2, the pump portion 40 includes a casing 41, a rotor 10, a shaft 11, and a cup-shaped partitioning part 80. The rotor 10 is rotatably supported by the shaft 11. The casing 41 and the cup-shaped partitioning part 80 are coupled together in an axial direction of the shaft 11 to form a housing. The rotor 10 is accommodated inside the housing.

A direction of an axis Cl, which is a center line of the shaft 11, is referred to as an “axial direction”. A circumferential direction (denoted with an arrow R1 in FIG. 1 and the like) about the axis Cl of the shaft 11 is referred to as a “circumferential direction”. A direction of a radius about the axis Cl of the shaft 11 is referred to as a “radial direction”. A sectional view in a section parallel to the axial direction is referred to as a “longitudinal sectional view”, and a sectional view in a section perpendicular to the axial direction is referred to as a “cross sectional view”.

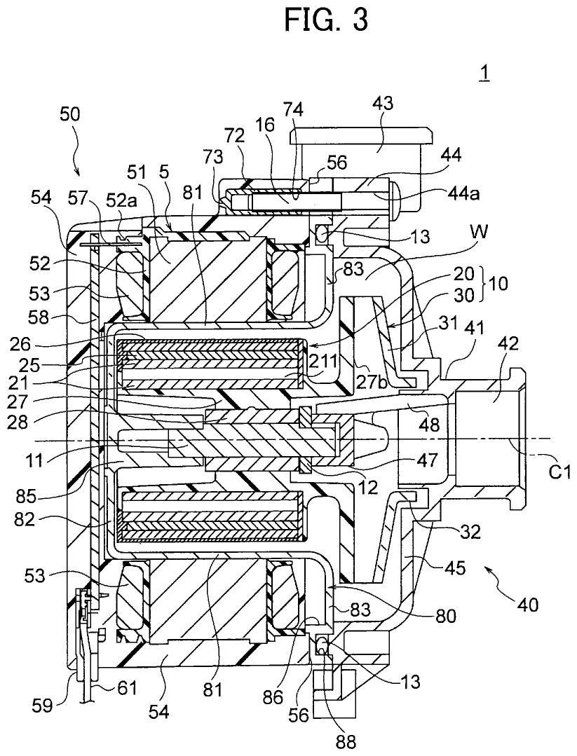

FIG. 3 is a longitudinal sectional view showing the pump 1. The molded stator 50 is provided to surround the cup-shaped partitioning part 80 from outside in the radial direction. A water path is formed around the rotor 10 disposed inside the cup-shaped partitioning part 80. The molded stator 50 is separated from the water path by the cup-shaped partitioning part 80. The casing 41 protrudes from the molded stator 50 in the axial direction (to the right side in FIG. 3).

### (Molded Stator 50)

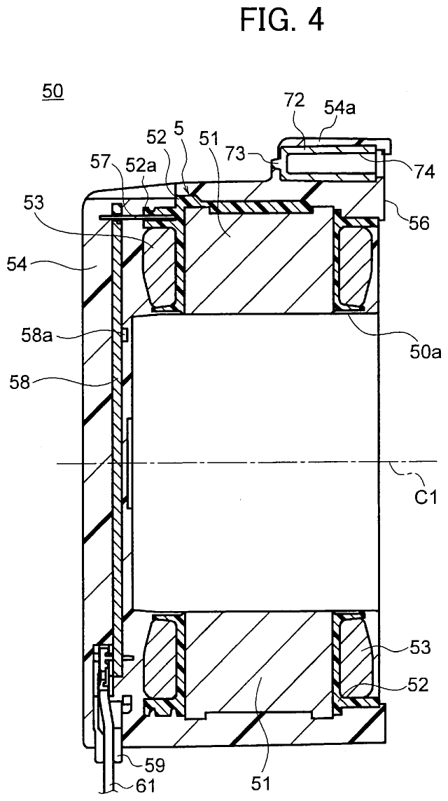

Next, the configuration of the molded stator 50 is described. FIG. 4 is a longitudinal sectional view showing the molded stator 50. The molded stator 50 includes a stator 5 and a mold resin portion 54 covering the stator 5. The stator 5 includes a stator core 51, an insulator 52 provided on the stator core 51, and a coil 53 wound on the stator core 51 via the insulator 52.

The stator core 51 is obtained by stacking a plurality of electromagnetic steel sheets in the axial direction and fixing them by crimping, welding, or bonding. The thickness of each electromagnetic steel sheet is 0.1 to 0.7 mm, for example. The stator core 51 includes a yoke that is annular about the axis Cl and a plurality of teeth extending inward from the yoke in the radial direction. The number of teeth is 12, for example. Inner ends of the teeth in the radial direction are exposed on an inner circumferential portion of the molded stator 50 shown in FIG. 1.

The insulator 52 is made of a thermoplastic resin, for example, PBT (polybutylene terephthalate). The insulator 52 is formed by molding the thermoplastic resin integrally with the stator core 51 or mounting a molded body of the thermoplastic resin to the stator core 51.

The coil 53 is formed by magnet wire and wound around the tooth via the insulator 52. The insulator 52 includes walls 52a on inner and outer sides of the coil 53 in the radial direction to guide the coil 53 from both sides in the radial direction.

A wiring board 58 is disposed on a side (the left side in FIG. 4) of the stator core 51 opposite to the casing 41 in the axial direction. A driving circuit 58a (FIG. 5) and Hall elements are mounted on the wiring board 58. The wiring board 58 is connected to the coil 53 via a terminal 57 provided on the insulator 52. Lead wires 61 are arranged on the wiring board 58. The lead wires 61 are drawn out to the outside through a lead-wire-outlet part 59 attached to an outer circumferential portion of the mold resin portion 54.

The pilot hole part 70 (FIG. 5) is disposed on the outer side in the radial direction with respect to the stator core 51. FIG. 5 is a perspective view showing the pilot hole part 70, the stator 5, and the wiring board 58. The pilot hole part 70 includes a plurality of columnar legs 72, each having the pilot hole 74 to which the tapping screw 16 (FIG. 1) is fastened, and an annular connecting portion 71 that connects these legs 72 to each other.

The number of legs 72 is five, which is the same as the number of tapping screws 16. Three of the legs 72 are shorter than the other legs 72 in the length in the axial direction, and have protrusions 73 at their tips in the axial direction. Each protrusion 73 is a portion that comes into contact with a contact surface of a mold when the stator 5, the wiring board 58, and the pilot hole part 70 are integrally molded with a resin. The number of legs 72 and the number of protrusions 73 are not limited to the examples described here.

The stator 5, the wiring board 58, and the pilot hole part 70 constitute a stator assembly 55. The stator assembly 55 is placed in a mold and integrally molded with a thermosetting resin such as BMC (bulk molding compound), so that the mold resin portion 54 (FIG. 4) covering the stator assembly 55 is formed.

The molded stator 50 is constituted by the stator assembly 55 and the mold resin portion 54. The molded stator 50, the rotor (FIG. 3), and the cup-shaped partitioning part 80 (FIG. 3) located between them constitute a motor 2.

As shown in FIG. 4, the mold resin portion 54 covers an outer side of the stator core 51 in the radial direction and also covers a side of the stator core 51 facing the wiring board 58 in the axial direction. A cavity 50a is formed on the inner side of the mold resin portion 54 in the radial direction. The cup-shaped partitioning part 80 and the rotor 10 are inserted into the cavity 50a.

The mold resin portion 54 has a casing-placing surface 56 on the casing 41 side. The casing-placing surface 56 is a flat surface perpendicular to the axial direction. The casing 41 is in contact with the casing-placing surface 56. The pilot holes 74 of the pilot hole part 70 described above are open on the casing-placing surface 56.

### (Pump Portion 40)

Next, the configuration of the pump portion 40 is described. The pump portion 40 includes the casing 41, the cup-shaped partitioning part 80, the shaft 11, and the rotor 10, as described with reference to FIG. 2. An O-ring 13 is provided between the casing 41 and the cup-shaped partitioning part 80.

### (Casing 41)

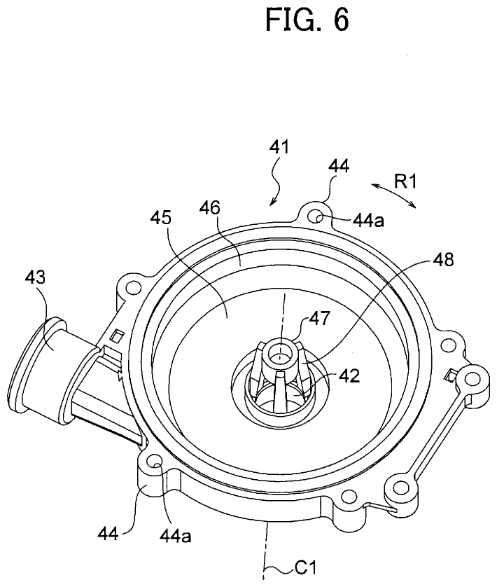

FIG. 6 is a perspective view of the casing 41 as seen from the rotor 10 side. The casing 41 is made of a thermoplastic resin such as PPS (polyphenylene sulfide). The casing 41 has a circular top plate 45 extending in a plane perpendicular to the axial direction and a circumferential wall 46 extending along a circumference of the top plate 45.

The casing 41 also has an inlet 42 (FIG. 1) and an outlet 43. The inlet 42 is a path for water flowing into the casing 41 and is open at the center of the top plate 45. The outlet 43 is a path for water discharged from the casing 41 to the outside and is open in the circumferential wall 46.

A plurality of boss portions 44 each having the through hole 44a extending in the axial direction are formed on the outer side of the circumferential wall 46 of the casing 41. The through hole 44a is formed at a position corresponding to the pilot hole (FIG. 4) of the pilot hole part 70 of the molded stator 50. The number of boss portions 44 is the same as the number of legs 72 of the pilot hole part 70 and is five here.

A cylindrical shaft support portion 47 is provided on the rotor 10 side with respect to the inlet 42. The shaft support portion 47 is located on the axis Cl and is supported by three arms 48 extending from a region surrounding the inlet 42. The shaft support portion 47 supports an end of the shaft 11 (FIG. 3).

With reference to FIG. 3 again, a thrust bearing 12 is provided between the shaft support portion 47 of the casing 41 and a sleeve bearing 28 (described later) of the rotor 10 in the axial direction. The thrust bearing 12 is an annular member and fits to one end of the shaft 11.

During operation of the pump 1, the rotor 10 is pressed against the casing 41 in the axial direction by a pressure difference between front and back sides of an impeller 30. The thrust bearing 12 is sandwiched between the shaft support portion 47 of the casing 41 and the sleeve bearing 28 of the rotor 10 and slides with respect to both the shaft support portion 47 and the sleeve bearing 28. For this reason, the thrust bearing 12 is made of a material having high abrasion resistance and high sliding property, for example, a ceramic material such as alumina.

### (Cup-Shaped Partitioning Part 80)

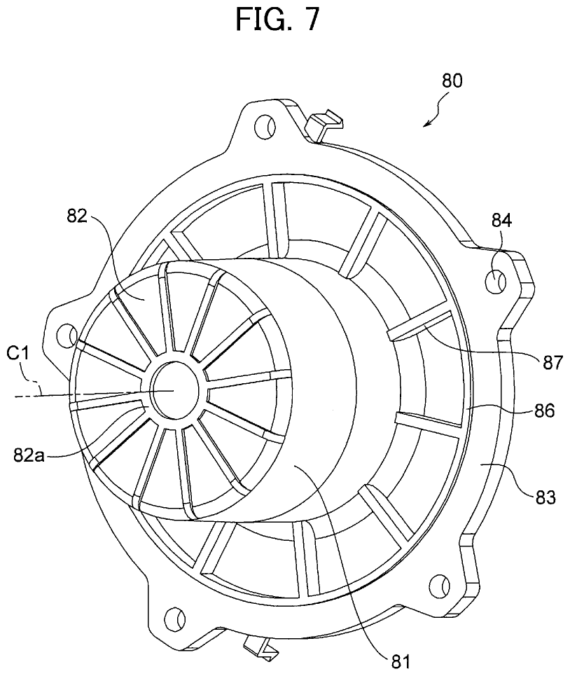

FIG. 7 is a perspective view of the cup-shaped partitioning part 80 as seen from the wiring board 58 side. The cup-shaped partitioning part 80 is made of a thermoplastic resin such as PPE (polyphenylene ether). The cup-shaped partitioning part 80 includes a partitioning portion 81 that is cylindrical about the axis Cl, a bottom portion 82 formed at one end in the axial direction of the partitioning portion 81, and a flange portion 83 formed at the other end in the axial direction of the partitioning portion 81. In the axial direction, the bottom portion 82 faces the wiring board 58, and the flange portion 83 faces the casing 41.

Convex reinforcing ribs 82a are formed on a surface of the bottom portion 82 facing the wiring board 58. A shaft support portion 85 (FIG. 3) supporting an end of the shaft 11 is formed at the center of the bottom portion 82 and protrudes in the axial direction. Grooves that engage with the reinforcing ribs 82a of the cup-shaped partitioning part 80 may be formed in the mold resin portion 54 of the molded stator 50 to position the cup-shaped partitioning part 80 and the molded stator 50 in a plane perpendicular to the axial direction.

The flange portion 83 has an annular rib 86 disposed on the casing-placing surface 56 (FIG. 4) of the molded stator 50 and a plurality of radial ribs 87 for reinforcing the flange portion 83. Through holes 84 are formed in the outer circumferential portion of the flange portion 83 to correspond to the pilot holes 74 of the pilot hole part 70. An annular O-ring accommodating groove 88 (FIG. 3) is formed on a surface of the flange portion 83 facing the casing 41. The O-ring 13 (described later) is accommodated in the annular O-ring accommodating groove 88.

As shown in FIG. 3, a rotor portion 20 attached to the shaft 11 is accommodated inside the partitioning portion 81 of the cup-shaped partitioning part 80. In order to ensure coaxial positioning of the molded stator 50 and the rotor portion 20, it is preferable to make a gap between the inner circumference of the molded stator 50 and the outer circumference of the partitioning portion 81 as narrow as possible.

Meanwhile, in the case where the gap between the inner circumference of the molded stator 50 and the outer circumference of the partitioning portion 81 is narrow, an air escape path is narrow when the partitioning portion 81 of the cup-shaped partitioning part 80 is inserted into the molded stator 50, which makes the insertion of the cup-shaped partitioning part 80 difficult. Therefore, the gap between the inner circumference of the molded stator 50 and the outer circumference of the partitioning portion 81 is desirably 0.02 to 0.06 mm.

In the case where a groove extending in the axial direction is provided as an air escape path on the inner circumference of the molded stator 50, the gap between the inner circumference of the molded stator 50 and the outer circumference of the partitioning portion 81 can be made narrower.

### (O-Ring 13)

The O-ring 13 serving as a seal member is accommodated in the O-ring accommodating groove 88 of the cup-shaped partitioning part 80. The O-ring 13 prevents entrance of water into a housing formed by the casing 41 and the cup-shaped partitioning part 80.

The O-ring 13 is made of EPDM (ethylene propylene diene monomer rubber) or the like in order to ensure heat resistance and long lifetime required for the pump 1 of a water heater. EPDM is obtained by adding a third component to EPM (ethylene propylene rubber), which is a copolymer of ethylene and propylene, to provide a double bond in the main chain. Various properties can be obtained depending on the type and amount of the third component. Typical examples of the third component include ethylidene norbornene (ENB), 1,4-hexadiene (1,4-HD), dicyclopentadiene (DCP), and the like.

### (Shaft 11)

The shaft 11 slides with the sleeve bearing 28 of the rotor portion 20 and is therefore made of a material having abrasion resistance and sliding property. Specifically, the shaft 11 is made of a ceramic material such as alumina or the like, or stainless steel.

A D-cut portion 11a (FIG. 2) is formed at each end of the shaft 11. The D-cut portion 11a has a sectional shape of a circle cut by a straight line. One end of the shaft 11 is inserted into the shaft support portion 85 of the cup-shaped partitioning part 80, while the other end of the shaft 11 is inserted into the shaft support portion 47 of the casing 41. Each of the shaft support portions 47 and 85 is shaped so as to fit to the D-cut portion 11a. The shaft 11 thus fits into the shaft support portion 47 of the casing 41 and the shaft support portion 85 of the cup-shaped partitioning part 80, and is supported by the shaft support portions 47 and 85.

### (Rotor 10)

As shown in FIG. 3, the rotor 10 includes the rotor portion 20 and the impeller 30. The rotor portion 20 and the impeller 30 are combined with each other in the axial direction and are joined to each other by ultrasonic welding or the like.

The impeller 30 is made of a resin, for example, a thermoplastic resin such as PPE. The impeller 30 has a cover 31 that is conical about the axis Cl. An inlet 32 is formed at the center of the cover 31 so as to face the inlet 42 of the pump portion 40. The cover 31 faces a flange portion 27b (described later) of the rotor portion 20 in the axial direction.

A blade 33 (FIG. 2) is provided between the cover 31 and the flange portion 27b. Here, a plurality of blades 33 are arranged in the circumferential direction. Water flowing into inside the impeller 30 through the inlet 32 flows outward in the radial direction by the blades 33 and is then discharged from the outer circumference of the impeller 30.

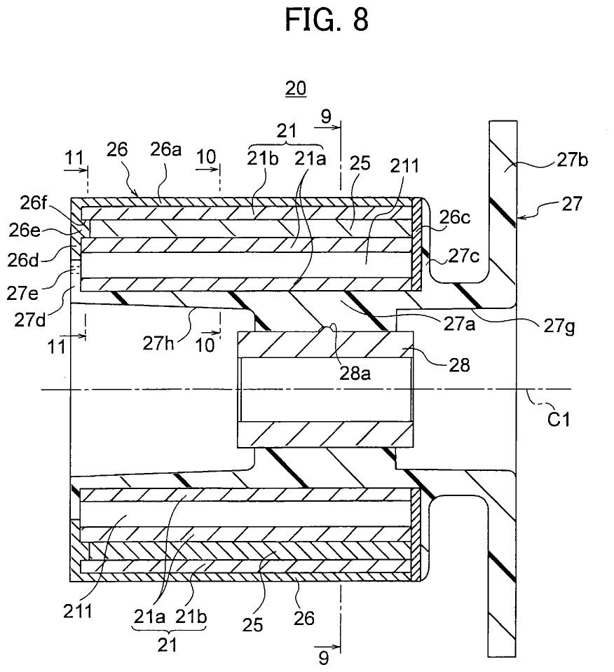

FIG. 8 is a longitudinal sectional view showing the rotor portion 20. The rotor portion 20 includes a rotor core 21, permanent magnets 25, a rotor cover 26, a resin portion 27, and the sleeve bearing 28.

The sleeve bearing 28 is a cylindrical member, and is rotatable while sliding on the outer circumferential surface of the shaft 11 fixed to the cup-shaped partitioning part 80. The sleeve bearing 28 is made of sintered carbon, a thermoplastic resin such as PPS with carbon fiber added thereto, or a ceramic material or the like.

The sleeve bearing 28 has a draft such that an outer diameter of the sleeve bearing 28 decreases from the center in the axial direction toward both ends. The sleeve bearing 28 has a hemispherical protrusion 28a for stopping rotation at the center in the axial direction. Here, a plurality of protrusions 28a are formed on the outer circumferential surface of the sleeve bearing 28 in the circumferential direction.

The resin portion 27 is provided between the sleeve bearing 28 and the rotor core 21. The resin portion 27 is made of, for example, a thermoplastic resin such as PPE. The resin portion 27 is formed by integrally molding the rotor core 21, the permanent magnets 25, the rotor cover 26, and the sleeve bearing 28 with the thermoplastic resin such as PPE, as described later.

The resin portion 27 includes an inner cylinder portion 27a located on the inner side of the rotor core 21 in the radial direction and the flange portion 27b facing the casing 41. The resin portion 27 also includes a resin end portion 27c covering the end surface of the rotor core 21 on the casing 41 side and a resin end portion 27d covering the end surface of the rotor core 21 on the wiring board 58 side. Both the resin end portions 27c and 27d extend outward in the radial direction from the inner cylinder portion 27a.

On the inner side of the resin portion 27 in the radial direction, a cavity 27g is formed on the casing 41 side, and a cavity 27h is formed on the wiring board 58 side. The cavity 27g accommodates therein the shaft support portion 47 of the casing 41 and the thrust bearing 12 described above. The cavity 27h accommodates therein the shaft support portion 85 of the cup-shaped partitioning part 80.

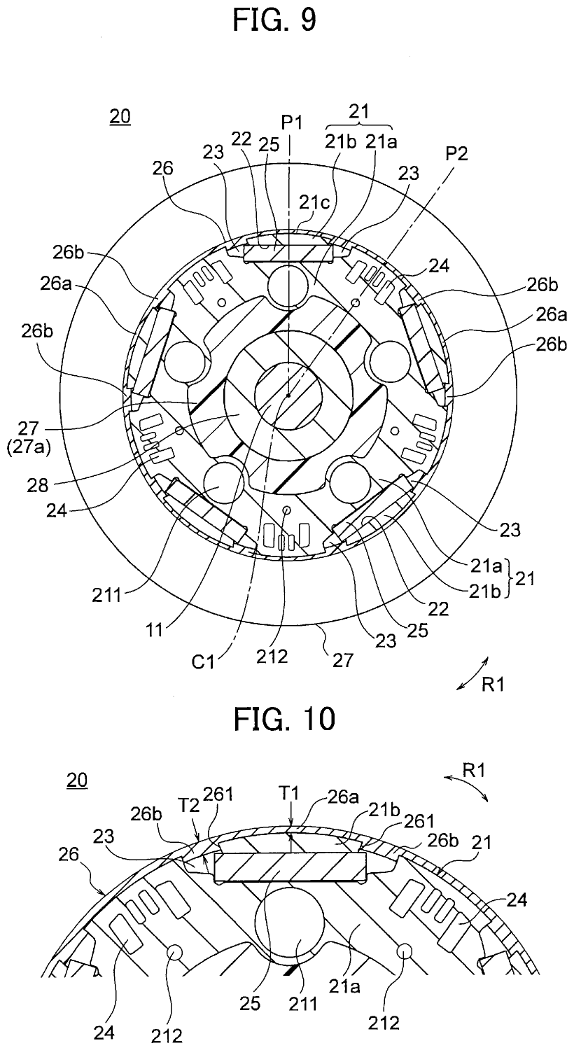

FIG. 9 is a sectional view of the rotor portion 20, taken along line 9-9 in FIG. 8. The shaft 11 is also shown in FIG. 9. The rotor core 21 is obtained by stacking a plurality of electromagnetic steel sheets in the axial direction and fixing them by crimping, welding, or bonding. The thickness of each electromagnetic steel sheet is 0.1 to 0.7 mm, for example.

The rotor core 21 has a plurality of magnet insertion holes 22. The magnet insertion holes 22 are disposed at constant intervals in the circumferential direction and at an equal distance from the axis Cl. The number of magnet insertion holes 22 is five here.

The permanent magnet 25 is inserted in each magnet insertion hole 22. The permanent magnet 25 is in the shape of a flat plate, and has a rectangular shape in a section perpendicular to the axial direction.

The permanent magnet 25 is a rare earth sintered magnet. More specifically, the permanent magnet 25 is a neodymium sintered magnet containing neodymium (Nd), iron (Fe), and boron (B). The rare earth sintered magnet generates a strong magnetic force and therefore improves a motor efficiency. Further, the rare earth sintered magnet has an advantage of having a high coercive force.

The permanent magnet 25 is not limited to the rare earth sintered magnet and may be a rare earth bond magnet. The rare earth bond magnet is obtained by mixing powder of a magnet, for example, a samarium-iron-nitrogen magnet containing samarium (Sm), iron, and nitrogen (N), and a resin. The rare earth bond magnet generates a strong magnetic force and thus improves the motor efficiency. The rare earth bond magnet has a lower coercive force as compared with the rare earth sintered magnet, but has an advantage of being able to be easily molded because it is a mixture of the magnetic powder and the resin.

The permanent magnets 25 are disposed in such a manner that the same magnetic poles (for example, the north poles) face to the outer circumference side of the rotor core 21. In the rotor core 21, a magnetic pole (for example, the south pole) opposite to that of the permanent magnets 25 is formed in a region between the permanent magnets 25 adjacent to each other in the circumferential direction.

Therefore, five first magnetic poles P1 (magnet magnetic poles) formed by the permanent magnets 25 and five second magnetic poles P2 (virtual magnetic poles) formed by the rotor core 21 are alternately arranged in the circumferential direction in the rotor portion 20, so that the number of poles is 10. This configuration is referred to as a consequent pole structure. In the following description, when the term “magnetic pole” is simply used, the term refers to either of the first magnetic pole P1 and the second magnetic pole P2.

The number of poles of the rotor portion 20 is not limited to 10 and may be any even number equal to or greater than four. Although one permanent magnet 25 is disposed in each magnet insertion hole 22 here, two or more permanent magnets 25 may be disposed in each magnet insertion hole 22.

An outer circumference 21c of the rotor core 21 has a so-called flower shape in a section perpendicular to the axial direction. In other words, the outer circumference 21c of the rotor core 21 is formed in such a manner that the outer diameter of the rotor core 21 is maximum at the pole center (i.e., the center in the circumferential direction) of each magnetic pole P1 or P2 and is minimum at each pole boundary, and the outer circumference 21 extends in an arc-shape from the pole center to the pole boundary. The shape of the outer circumference 21c of the rotor core 21 is not limited to a flower shape and may be a circular shape.

A hole 23 is formed at each side of the magnet insertion hole 22 of the rotor core 21 in the circumferential direction. The hole 23 is formed continuously with the magnet insertion hole 22 and reaches the outer circumference of the rotor core 21. Therefore, the holes 23 divide the rotor core 21 into a first core portion 21a on the inner side of the magnet insertion holes 22 in the radial direction and second core portions 21b on the outer side of the magnet insertion holes 22 in the radial direction. The first core portion 21a is separated from each second core portion 21b. The hole 23 is hollow, but the hole 23 may be filled with a non-magnetic material.

Slits 24 elongated in the radial direction are formed in the second magnetic pole P2 of the rotor core 21. Here, four slits 24 are formed in each second magnetic pole P2. The four slits 24 are disposed symmetrically with respect to the pole center. However, the number and arrangement of the slits 24 are not limited to the example described here. The second magnetic pole P2 may be configured to have no slit 24.

In the consequent pole type rotor portion 20, a magnetic flux flowing through the second magnetic pole P2 has a high degree of freedom. Therefore, a surface magnetic flux of the rotor portion 20 is largely changed depending on a relative rotational position of the rotor portion 20 with respect to the stator 5. For this reason, the second magnetic pole P2 is provided with the slits 24 to limit the degree of freedom of the magnetic flux, thereby making a surface magnetic flux distribution on the rotor portion 20 closer to a sine wave.

The rotor core 21 has a core hole 211 on the inner side of the pole center of each first magnetic pole P1 in the radial direction. Since the consequent pole type rotor portion 20 does not include a permanent magnet in the second magnetic pole P2, a magnetic flux from the first magnetic pole P1 tends to be disturbed. By arranging the core hole 211 at the pole center of the first magnetic pole P1, the flow of magnetic flux is regulated, so that vibration and noise of the rotor portion 20 are reduced.

The core holes 211 may be formed to penetrate through the rotor core 21 in the axial direction or formed only at an end of the rotor core 21 on the wiring board 58 side in the axial direction. The core holes 211 are provided for positioning the rotor core 21 by engaging with positioning protrusions of a mold 90. Further, in the rotor core 21, a crimping portion 212 for fixing a plurality of electromagnetic steel sheets constituting the rotor core 21 is formed on the inner side of the pole center of each second magnetic pole P2 in the radial direction.

The rotor portion 20 has the rotor cover 26 on the outer side of the rotor core 21 in the radial direction. The rotor cover 26 is made of a non-magnetic metal, for example, stainless steel. The rotor cover 26 is given a shape shown in FIGS. 8 to 10 by press working of metal.

As shown in FIG. 8, the rotor cover 26 includes a cover cylinder portion 26a covering the outer side of the rotor core 21 in the radial direction, a cover top plate (a second end surface portion) 26c covering the end surface of the rotor core 21 on the casing 41 side, and a cover bottom portion (a first end surface portion) 26d covering the end surface of the rotor core 21 on the wiring board 58 side.

The cover bottom portion 26d extends inward in the radial direction from the cover cylinder portion 26a to a position at which the cover bottom portion 26d is in contact with an outer end of the resin end portion 27d in the radial direction. The cover bottom portion 26d has protrusions 26e that enter inside the magnet insertion holes 22 of the rotor core 21.

FIG. 10 is a cross sectional view of the rotor portion 20, taken along line 10-10 in FIG. 8. As described above, the rotor core 21 includes the first core portion 21a on the inner side of the magnet insertion hole 22 in the radial direction and the second core portion 21b on the outer side of the magnet insertion hole 22. The second core portion 21b is separated from the first core portion 21a by the magnet insertion hole 22 and the holes 23 on both sides of the magnet insertion hole 22. For this reason, the outer side of the rotor core 21 in the radial direction is covered by the rotor cover 26 so as to prevent the second core portions 21b from being detached from the rotor portion 20.

The rotor cover 26 has convex portions 26b on the inner side in the radial direction, and each convex portion 26b serves as a positioning portion engaging with the hole 23. Although the convex portion 26b is formed to enter the hole 23, the convex portion 26b does not need to fill the hole 23. Although the convex portion 26b is rectangular here, the shape of the convex portion 26b is not limited thereto. It is sufficient that ends 261 on both sides of the convex portion 26b in the circumferential direction are in contact with both ends of the hole 23 in the circumferential direction, that is, the first core portion 21a and the second core portion 21b.

The outer circumference of the rotor cover 26 is circular here. When a thickness of a portion of the rotor cover 26 located on the outer side of the pole center of each magnetic pole P1 or P2 in the radial direction is T1, a thickness T2 of the convex portion 26b in the radial direction is thicker than the above-described thickness T1. However, the configuration of the convex portion 26b is not limited thereto. The convex portion 26b may be formed by deforming a cylindrical member, the thickness of which is constant in the circumferential direction, inward in the radial direction.

The cover cylinder portion 26a of the rotor cover 26 covers the rotor core 21 from outside in the radial direction, and thus a positional displacement in the radial direction between the first core portion 21a and the second core portion 21b is prevented. Further, the convex portion 26b of the rotor cover 26 engages with the hole 23 of the rotor core 21, and thus a positional displacement in the circumferential direction between the first core portion 21a and the second core portion 21b can be prevented.

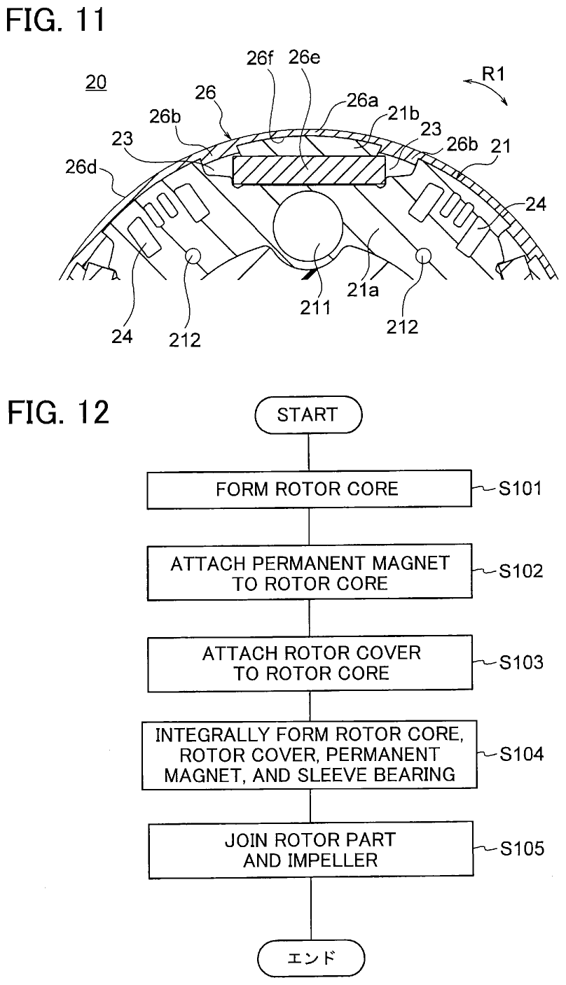

FIG. 11 is a sectional view of the rotor portion 20, taken along line 11-11 in FIG. 8. As described above, the cover bottom portion 26d (FIG. 8) has the protrusions 26e each entering the inside of the magnet insertion hole 22 of the rotor core 21. A concave portion 26f is formed in the cover bottom portion 26d between each protrusion 26e and the cover cylinder portion 26a.

The second core portion 21b fits into the concave portion 26f of the rotor cover 26. Therefore, a positional displacement of the second core portion 21b in the circumferential direction and the radial direction can be prevented by the concave portion 26f.

That is, the concave portion 26f of the rotor cover 26 also corresponds to a positioning portion that positions the first core portion 21a and the second core portion 21b in the circumferential direction. Here, the rotor cover 26 has both the convex portions 26b (FIG. 10) and the concave portions 26f (FIG. 11) as the positioning portions, but the rotor cover 26 may have only either of them.

With reference to FIG. 8 again, the cover cylinder portion 26a and the cover bottom portion 26d are desirably formed integrally with each other. In contrast, the cover top plate 26c is desirably formed as a separate member from the cover cylinder portion 26a and the cover bottom portion 26d. With this configuration, the rotor core 21 can be inserted into a container formed by the cover cylinder portion 26a and the cover bottom portion 26d, and thereafter the cover top plate 26c can be fixed to the cover cylinder portion 26a.

### (Manufacturing Method of Rotor 10)

Next, a manufacturing method of the rotor 10 is described. FIG. 12 is a flowchart showing a manufacturing process of the rotor 10. First, electromagnetic steel sheets are stacked and fixed by crimping or the like to form the rotor core 21 (Step S101). Next, the permanent magnets 25 are inserted into the magnet insertion holes 22 of the rotor core 21 (Step S102).

Then, the rotor cover 26 is attached to the rotor core 21 (Step S103). The rotor cover 26 has the cover cylinder portion 26a and the cover bottom portion 26d (FIG. 8) integrated with each other as described above, and the rotor core 21 is attached inside the cover cylinder portion 26a. Thereafter, the cover top plate 26c is fixed to an end surface of the cover cylinder portion 26a by bonding or the like. The rotor cover 26 may be formed by integral molding together with the rotor core 21.

Then, the rotor core 21, the permanent magnets 25, and the rotor cover 26 are integrally molded with a resin such as PPE, together with the sleeve bearing 28 (Step S104).

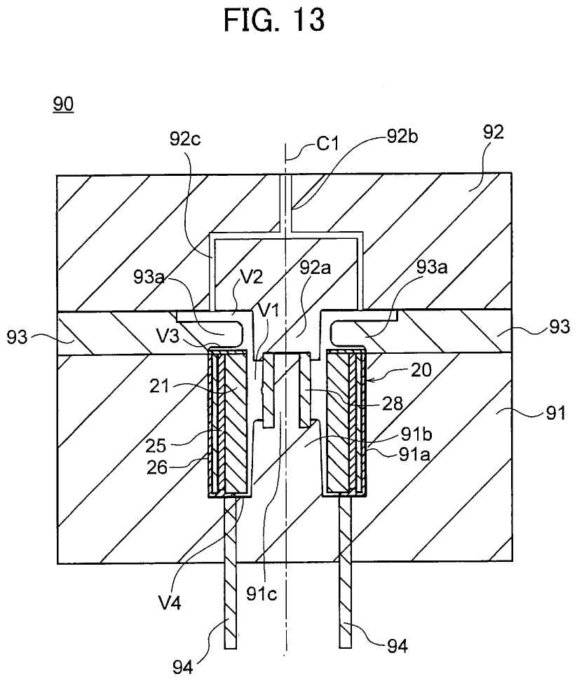

FIG. 13 is a longitudinal sectional view for explaining a molding process. The mold 90 includes a fixed mold (lower mold) 91, a movable mold (upper mold) 92, and a pair of slidable molds 93. The movable mold 92 can be moved up and down with respect to the fixed mold 91. In FIG. 13, the center axis of the mold 90 coincides with the axis Cl that is the center of the rotor portion 20.

The fixed mold 91 has an accommodating portion 91a that accommodates therein the rotor core 21, the permanent magnets 25, the rotor cover 26, and the sleeve bearing 28.

The fixed mold 91 also has a core 91b protruding into the accommodating portion 91a in the axial direction and a shaft portion 91c protruding in the axial direction from the tip of the core 91b. The core 91b is for forming the cavity 27h (FIG. 8) of the resin portion 27. The sleeve bearing 28 fits to the shaft portion 91c. Both the core 91b and the shaft portion 91c are located on the axis Cl.

Although not shown in the figure, positioning protrusions that are to engage with the core holes 211 (FIG. 9) of the rotor core 21 are formed on a bottom surface of the accommodating portion 91a of the fixed mold 91. These protrusions are formed at positions where these protrusions do not to overlap ejectors 94 described next in a plane perpendicular to the axial direction.

The fixed mold 91 is provided with the ejectors 94 that push a molded body upward after completion of molding. The ejectors 94 are elongated in a direction parallel to the axis Cl and are movable in the longitudinal direction. In the state shown in FIG. 13, an upper end surface of each ejector 94 is located on the same plane as the bottom surface of the accommodating portion 91a of the fixed mold 91. The ejectors 94 move upward from the state shown in FIG. 13, thereby pushing the molded body upward.

The pair of slidable molds 93 are disposed between the fixed mold 91 and the movable mold 92, and face each other across the axis Cl. Further, the slidable molds 93 are movable in directions toward and away from each other.

When the slidable molds 93 are at the positions shown in FIG. 13, a cavity serving as a molding space is formed by the fixed mold 91, the movable mold 92, and the slidable molds 93. Convex portions 93a are provided on sides of the slidable molds 93 facing each other. On both sides of the convex portion 93a in the axial direction in the above cavity, cavity portions V2 and V3 are formed. The cavity portions V2 and V3 are provided for forming the flange portion 27b and the resin end portion 27c of the resin portion 27.

The movable mold 92 has a sprue 92b into which a melted resin injected from an injection molding machine flows and a plurality of runners 92c that branch from the tip of the sprue 92b and reach the cavity.

The movable mold 92 also has a convex portion 92a protruding into the cavity. This convex portion 92a is for forming the cavity 27g (FIG. 8) of the resin portion 27. An end of the convex portion 92a fits into an end of the sleeve bearing 28 attached to the shaft portion 91c of the fixed mold 91.

In the above Step S104 (FIG. 12), the movable mold 92 is first moved up away from the fixed mold 91, and then the pair of slidable molds 93 are slid in directions away from each other, whereby an upper portion of the accommodating portion 91a of the fixed mold 91 is opened.

In this state, the sleeve bearing 28 is attached to the shaft portion 91c of the fixed mold 91. In addition, the rotor core 21 to which the permanent magnets 25 and the rotor cover 26 are attached in Steps S102 and S103 is inserted into the accommodating portion 91a of the fixed mold 91. The protrusions of the fixed mold 91 engage with the core holes 211 (FIG. 9) of the rotor core 21 at this time, whereby the rotor core 21 is positioned in the accommodating portion 91a.

Thereafter, the movable mold 92 is moved down, and the pair of slidable molds 93 are slid in directions toward each other, whereby the upper portion of the accommodating portion 91a of the fixed mold 91 is closed to form the cavity as shown in FIG. 13.

Subsequently, the mold 90 is heated, and a melted resin such as PPE is injected through the sprue 92b and the runners 92c. The resin is filled in the cavity surrounded by the fixed mold 91, the movable mold 92, and the slidable molds 93.

Thereafter, the mold 90 is cooled. Accordingly, the resin in the cavity of the mold 90 is hardened, so that the resin portion 27 is formed. That is, the rotor core 21, the permanent magnets 25, the rotor cover 26, and the sleeve bearing 28 are integrated with one another with the resin portion 27, whereby the rotor portion 20 is formed.

Specifically, the resin hardened in a cavity portion V1 forms the inner cylinder portion 27a of the resin portion 27. The cavity portion V1 is provided on the inner side in the radial direction of the rotor core 21 in the accommodating portion 91a of the fixed mold 91 and on the inner side in the radial direction of the convex portions 93a of the slidable molds 93.

The resin hardened in the cavity portion V2 between the convex portions 93a of the slidable molds 93 and the movable mold 92 forms the flange portion 27b of the resin portion 27. The resin hardened in the cavity portion V3 between the convex portions 93a of the slidable molds 93 and the fixed mold 91 forms the resin end portion 27c of the resin portion 27.

The resin hardened in a cavity portion V4 between the accommodating portion 91a of the fixed mold 91 and the rotor core 21 forms a resin end portion 27d of the resin portion 27. In the resin end portion 27d, holes 27e (indicated by broken lines in FIG. 8) are formed which correspond to the above-described positioning protrusions.

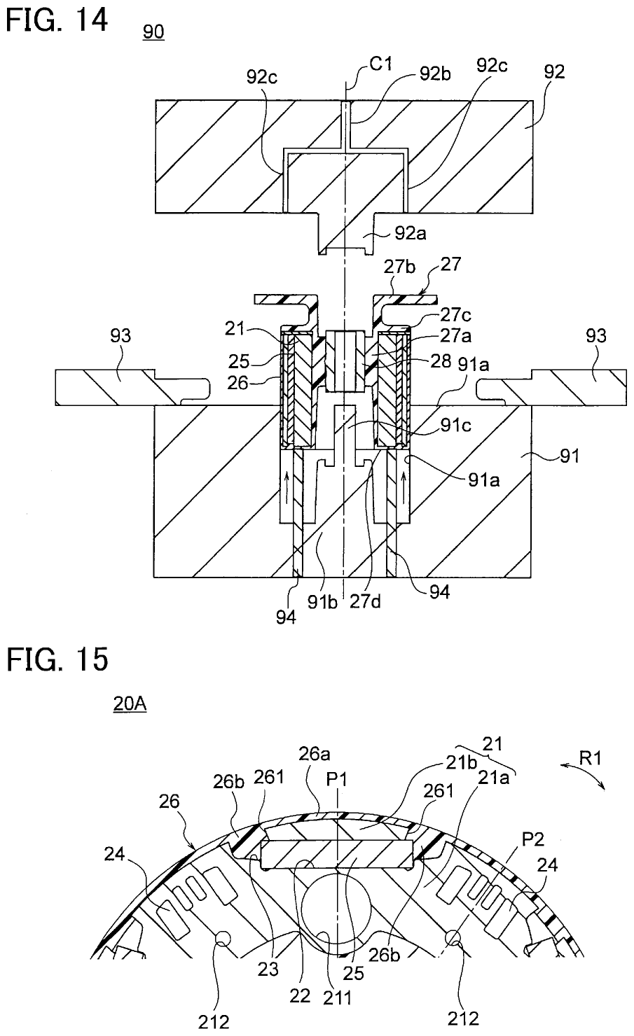

After hardening of the resin in the mold 90 is completed, the movable mold 92 is moved up, and the slidable molds 93 are slid in directions away from the axis Cl, as shown in FIG. 14. Thereafter, the ejectors 94 are moved up, and the rotor portion 20 is taken out from the accommodating portion 91a. The rotor portion 20 is thus completed.

Then, the impeller 30 made of a thermoplastic resin such as PPE is joined to the rotor portion 20 by ultrasonic welding or the like (Step S105). Thus, the rotor 10 including the rotor portion 20 and the impeller 30 is completed.

Thereafter, the shaft 11 is attached to the shaft support portion 85 (FIG. 3) of the cup-shaped partitioning part 80 molded using a thermoplastic resin such as PPE, as shown in FIG. 2. Further, the rotor 10 is attached around the shaft 11 in the cup-shaped partitioning part 80. Subsequently, the O-ring 13 is attached to the cup-shaped partitioning part 80, and the casing 41 molded using a thermoplastic resin such as PPS is attached to the cup-shaped partitioning part 80. Thus, the pump portion 40 is completed.

Meanwhile, the stator core 51 (FIG. 3) is formed by stacking electromagnetic steel sheets and fixing them by crimping or the like. The insulator 52 is attached to the stator core 51, and the coil 53 is wound on the stator core 51, thereby forming the stator 5. Further, the wiring board 58 with the lead wires 61 arranged thereon is attached to the stator 5. Specifically, the protrusions 52b (FIG. 5) provided on the insulator 52 of the stator 5 are inserted through attachment holes of the wiring board 58 and are welded by heat welding or ultrasonic welding, so that the wiring board 58 is fixed to the insulator 52.

The stator 5 with the wiring board 58 fixed thereto is then placed together with the pilot hole part 70 (FIG. 5) in a mold. A resin such as BMC (mold resin) is then injected and heating is performed. Accordingly, the mold resin portion 54 is formed to cover the stator 5, the wiring board 58, and the pilot hole part 70. The molded stator 50 is thus completed.

Thereafter, the pump portion 40 and the molded stator 50 are fixed to each other with the tapping screws 16, as shown in FIG. 1. The tapping screws 16 penetrate through the through holes 44a of the pump portion 40 and are fastened to the pilot holes 74 of the pilot hole part 70 embedded in the mold resin portion 54 of the molded stator 50. The pump 1 is thus completed.

### (Action)

In the pump 1, it is desirable to use the motor 2 of an IPM (Interior Permanent Magnet) type in which the rotor portion 20 is disposed inside the stator 5 and each permanent magnet 25 is formed of a rare earth sintered magnet or a rare earth bond magnet, in order to reduce the size and increase the output.

In this case, the rotor core 21 is divided into the first core portion 21a on the inner side of the magnet insertion hole 22 in the radial direction and the second core portion 21b on the outer side of the magnet insertion hole 22 in the radial direction. Generally, the first core portion 21a and the second core portion 21b are connected to each other by the bridge portions on both sides of the magnet insertion hole 22. The bridge portion is usually formed to have a width (a dimension in the circumferential direction) wider than a thickness of the electromagnetic steel sheet so as to prevent deformation such as distortion.

However, in the case where the first core portion 21a and the second core portion 21b are connected to each other by the bridge portions, a magnetic flux exiting from the permanent magnet 25 returns to the permanent magnet 25 through the bridge portion. In other words, a magnetic flux leakage occurs. This magnetic flux leakage leads to reduction of the motor efficiency.

In particular, in the pump 1, the outer diameter of the rotor portion 20 is relatively small, because the water path is provided around the rotor portion 20 and the cup-shaped partitioning part 80 is disposed between the rotor portion 20 and the stator 5. Therefore, the ratio of the bridge portion to the outer diameter of the rotor portion 20 is large, and the magnetic flux leakage tends to lead to reduction of the motor efficiency.

In contrast, the first core portion 21a and the second core portion 21b of the rotor core 21 are not connected to each other by bridge portions in the first embodiment. That is, the first core portion 21a on the inner side of the magnet insertion hole 22 in the radial direction and the second core portion 21b on the outer side of the magnet insertion hole 22 in the radial direction are separated from each other by the holes 23. However, if the first and second core portions 21a and 21b are only separated from each other, a relative positional displacement between the first core portion 21a and the second core portion 21b is likely to occur.

For this reason, the rotor cover 26 is provided to cover the rotor core 21, thereby preventing a positional displacement in the radial direction between the first core portion 21a and the second core portion 21b. A positional displacement in the circumferential direction between the first core portion 21a and the second core portion 21b is prevented by the convex portions 26b and the concave portions 26f (positioning portions) of the rotor cover 26.

Thus, the rotor core 21 can be configured in such a manner that the first core portion 21a and each second core portion 21b of the rotor core 21 are not connected to each other by the bridge portion, thereby reducing the magnetic flux leakage and improving the motor efficiency.

### Advantages of Embodiment

As described above, the rotor 10 according to the first embodiment includes the annular rotor core 21 that has the magnet insertion holes 22, the permanent magnets 25 disposed in the magnet insertion holes 22, and the rotor cover 26 surrounding the rotor core 21 from outside in the radial direction. The rotor core 21 has the first core portion 21a located on the inner side of the magnet insertion hole 22 in the radial direction, the second core portion 21b located on the outer side of the magnet insertion hole 22 in the radial direction, and the holes 23 that separate the first core portion 21a and the second core portion 21b from each other. The rotor cover 26 has the convex portion 26b and the concave portion 26f serving as the positioning portions that position the first core portion 21a and the second core portion 21b in the circumferential direction.

The first core portion 21a and the second core portion 21b can be positioned in the radial direction by the rotor cover 26 surrounding the rotor core 21. Further, the first core portion 21a and the second core portion 21b can be positioned in the circumferential direction by the positioning portions (26b, 26f) of the rotor cover 26. Therefore, a configuration in which the first core portion 21a and the second core portion 21b are separated from each other can be enabled, and the magnetic flux leakage can be suppressed and the motor efficiency can be improved.

Further, since the convex portion 26b of the rotor cover 26 engages with the hole 23 of the rotor core 21, the first core portion 21a and the second core portion 21b can be positioned in the circumferential direction with a simple configuration. Furthermore, the convex portion 26b can be formed over the entire length of the rotor cover 26 in the axial direction. This configuration enhances the effect of positioning the first core portion 21a and the second core portion 21b.

The rotor cover 26 includes the cover cylinder portion 26a surrounding the rotor core 21, and the convex portion 26b protrudes inward from the cover cylinder portion 26a in the radial direction. Therefore, the rotor cover 26 can be simply formed by press working or the like.

Further, the rotor cover 26 includes the cover bottom portion (the first end surface portion) 26d that is in contact with one end surface of the rotor core 21 in the axial direction, and the concave portion 26f formed in the cover bottom portion 26d engages with the second core portion 21b. Therefore, the first core portion 21a and the second core portion 21b can be positioned in the circumferential direction at the one end of the rotor core 21.

Furthermore, the rotor cover 26 includes the cover top plate (the second end surface portion) 26c facing the cover bottom portion 26d in the axial direction. Therefore, the first core portion 21a and the second core portion 21b can be positioned in the axial direction by the cover bottom portion 26d and the cover top plate 26c.

In addition, the rotor cover 26 is made of a non-magnetic metal. Thus, the rotor cover 26 can be easily given a shape by press working, and a magnetic flux leakage from the rotor cover 26 can be suppressed.

Further, the resin portion 27 is further provided to hold the rotor core 21, the permanent magnets 25, and the rotor cover 26. Therefore, the rotor portion 20 can be formed by integral molding using a resin.

Since the sleeve bearing 28 is held by the resin portion 27 together with the rotor core 21, the permanent magnets 25, and the rotor cover 26, the rotor portion 20 can be configured to be rotatable about the shaft 11.

When the permanent magnet 25 is formed of a rare earth sintered magnet, a strong magnetic force can be obtained, and the motor efficiency can be improved. Further, a high coercive force is obtained, and thus motor performance can be improved.

When the permanent magnet 25 is formed of a rare earth bond magnet, a strong magnetic force can be obtained, and the motor efficiency can be improved. Further, the rare earth bond magnet contains magnetic powder and a resin, and thus molding is facilitated.

Further, the rotor 10 has a consequent pole structure in which the permanent magnets 25 constitute the magnet magnetic poles (the first magnetic poles P1) and portions of the rotor core 21 constitute the virtual magnetic poles (the second magnetic poles P2). Therefore, the number of permanent magnets 25 can be reduced, and the manufacturing cost can be reduced.

Since the motor 2 includes the rotor 10, the cup-shaped partitioning part 80 surrounding the rotor 10, and the molded stator 50 surrounding the rotor 10 from outside in the radial direction via the cup-shaped partitioning part 80, the water path can be formed inside the cup-shaped partitioning part 80. Thus, the molded stator 50 can be separated from the water path by the cup-shaped partitioning part 80.

In addition, the pump 1 includes the pump portion 40 having the casing 41 surrounding the impeller 30 of the rotor 10. Therefore, the pump 1 can perform an operation of sucking water into the casing 41 and discharging the water therefrom by rotating the impeller 30.

### Second Embodiment

Next, a second embodiment is described. FIG. 15 is an enlarged cross sectional view showing a portion of a rotor portion 20A according to the second embodiment. The rotor cover 26 of the first embodiment is made of a non-magnetic metal. In contrast, the rotor cover 26 of the second embodiment is made of a resin, more specifically, a thermoplastic resin.

A specific example of the thermoplastic resin forming the rotor cover 26 is PPS. By using of the thermoplastic resin such as PPS, the rotor cover 26 can be integrally molded with a resin together with the rotor core 21, the permanent magnets 25, and the sleeve bearing 28.

The rotor cover 26 has the convex portions 26b that engage with the holes 23 in the rotor core 21. In the case where the rotor cover 26 is integrally molded with the resin together with the rotor core 21 and the like as described above, the convex portions 26b are formed to fill the holes 23.

The rotor cover 26 and the resin portion 27 (FIG. 8) may also be formed of the same resin. In this case, the rotor cover 26 and the resin portion 27 can be molded in one molding process, and thereby simplifying a manufacturing process.

The configuration of the rotor portion 20A according to the second embodiment is the same as the rotor portion 20 according to the first embodiment except that the rotor cover 26 is made of a resin and the convex portions 26b are formed to fill the holes 23.

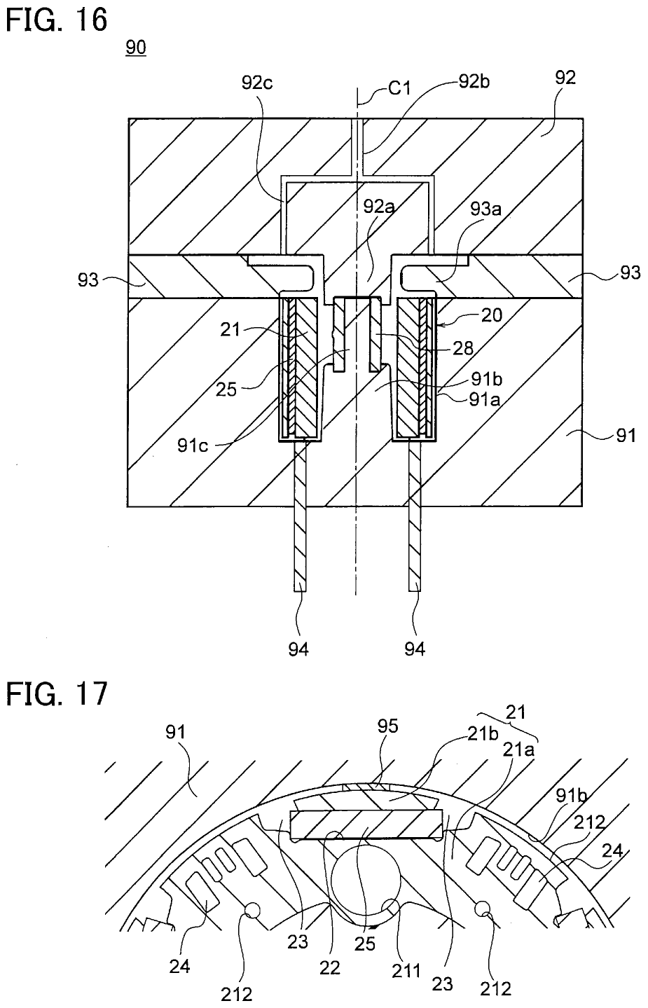

FIG. 16 is a diagram for explaining a manufacturing process of the rotor portion 20A according to the second embodiment. The mold 90 shown in FIG. 16 is the same as the mold 90 described in the first embodiment with reference to FIGS. 13 and 14.

In the manufacturing process of the rotor portion 20A according to the second embodiment, the rotor core 21 with the permanent magnets 25 attached thereto is inserted into the accommodating portion 91a of the fixed mold 91 of the mold 90. The sleeve bearing 28 is fitted to the shaft portion 91c of the mold 90, as in the first embodiment.

In this stage, the rotor cover 26 is not yet provided, and thus the second core portion 21b has to be positioned in the accommodating portion 91a of the fixed mold 91. Therefore, as shown in the cross sectional view of FIG. 17, a positioning portion 95 is provided in the accommodating portion 91a to hold each second core portion 21b at its outer circumferential surface.

An inner circumferential surface of the positioning portion 95 is shaped to face the outer circumferential surface of the second core portion 21b. An operator attaches the first core portion 21a and the permanent magnet 25 between the positioning portion 95 and the rotor core 21 in a state where the second core portion 21b is adjusted in the circumference direction. The positioning portions 95 are provided at a plurality of positions in the axial direction of the rotor core 21 although not shown in FIG. 16.

A resin such as PPS is caused to flow into a cavity in the mold 90 through the sprue 92b and the runners 92c of the movable mold 92, whereby the rotor cover 26 and the resin portion 27 can be simultaneously molded.

In molding, no resin flows into portions where the positioning portions 95 are disposed in the accommodating portion 91a of the mold 90. Thus, dents are formed in the rotor cover 26 at the portions where the positioning portions 95 are disposed. These dents have to be filled with a resin such as PPS in a later process.

The rotor cover 26 and the resin portion 27 are molded in this manner, thereby forming the rotor portion 20A. The impeller 30 is joined to the rotor portion 20A, so that the rotor 10 is obtained.

Except for the points described above, the rotor portion 20A according to the second embodiment is configured in a similar manner to the rotor portion 20 according to the first embodiment.

As described above, the rotor cover 26 is made of a resin in the second embodiment. Therefore, the rotor portion 20A can be manufactured by integrally molding the rotor core 21, the permanent magnets 25, and the sleeve bearing 28 with the resin, so that the manufacturing process of the rotor 10 can be simplified.

Further, the manufacturing process of the rotor 10 can be further simplified by molding the rotor cover 26 and the resin portion 27 integrally with each other.

Here, a case where the rotor core 21, the permanent magnets 25, and the sleeve bearing 28 are integrally molded with the resin has been described. However, the rotor cover 26 may be molded in advance to have the same shape as the rotor cover 26 described in the first embodiment, and then the rotor core 21 may be attached to the rotor cover 26. In this case, the rotor cover 26, the rotor core 21, and the sleeve bearing 28 are integrally molded with the resin portion 27, as in the first embodiment.

### First Modification

Next, a first modification of the first and second embodiments described above is described. FIG. 18 is an enlarged cross sectional view showing a portion of a rotor portion 20B according to the first modification. The convex portions 26b (FIGS. 10 and 15) in the first and second embodiments are rectangular.

In contrast, the convex portion (positioning portion) 26b according to the first modification has a curved shape portion 262 that is smoothly curved so as to enter the hole 23. Inclined surfaces of the curved shape portion 262 on both sides in the circumferential direction are in contact with ends of the hole 23 on both sides in the circumferential direction. This configuration can suppress a positional displacement between the first core portion 21a and the second core portion 21b in the circumferential direction.

Except for the points described above, the rotor portion 20B according to the first modification is configured in a similar manner to the rotor portion 20 according to the first embodiment. In this regard, the rotor cover 26 may be made of the resin as in the second embodiment.

In this first modification, the convex portion 26b of the rotor cover 26 has a curved shape, and thus stress concentration is less likely to occur on the rotor cover 26. Therefore, durability of the rotor cover 26 can be improved, and the lifetime of the rotor cover 26 can be lengthened.

### Second Modification

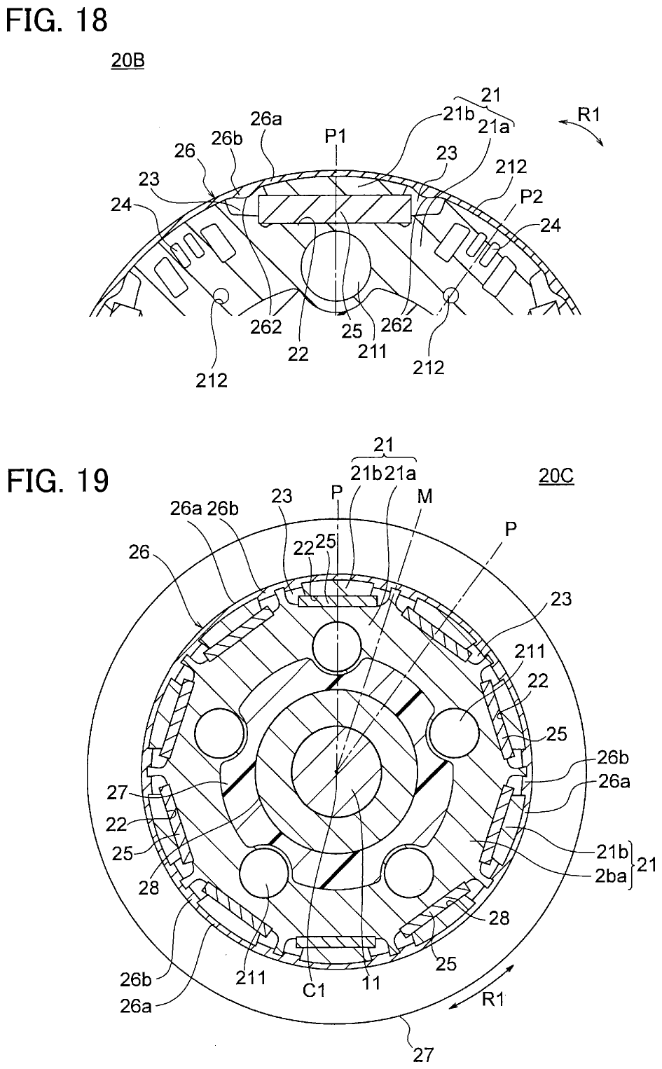

FIG. 19 is a cross sectional view showing a rotor portion 20C according to a second modification. The rotor portions 20 and 20A according to the first and second embodiments have a consequent pole structure.

In contrast, the rotor portion 20C according to the second modification has a non-consequent pole structure. More specifically, the rotor core 21 has 10 magnet insertion holes 22 in the circumferential direction in each of which the permanent magnet 25 is disposed. The permanent magnets 25 disposed in the adjacent magnet insertion holes 22 have opposite magnetic poles that face radially outward.

That is, all 10 magnetic poles P are formed by magnet magnetic poles, i.e., the permanent magnets 25 in the rotor core 21. A portion between the adjacent magnetic poles P is a pole boundary M. Although the number of poles of the rotor portion 20C is 10 here, it is not limited to 10 and only needs to be two or more.

The hole 23 is formed on each side of the magnet insertion hole 22 in the circumferential direction, and continuously formed with the magnet insertion hole 22. The rotor core 21 is divided into the first core portion 21a on the inner side of the magnet insertion hole 22 in the radial direction and the second core portion 21b on the outer side of the magnet insertion hole 22 in the radial direction.

The rotor cover 26 is provided on the outer side of the rotor core 21 in the radial direction. The rotor cover 26 has the cover cylinder portion 26a surrounding the rotor core 21. The cover cylinder portion 26a has the convex portions 26b entering the holes 23 in the rotor core 21.

Further, the cover cylinder portion 26a is provided with the concave portions 26f (FIG. 8) described in the first embodiment at its end in the axial direction. The convex portions 26b and the concave portions 26f correspond to positioning portions that position the first core portion 21a and the second core portion 21b in the circumferential direction. The rotor core 21 may include only either of the convex portions 26b and the concave portions 26f.

Except for the points described above, the rotor portion 20C according to the second modification is configured in a similar manner to the rotor portion 20 according to the first embodiment. In this regard, the rotor cover 26 may be made of a resin as in the second embodiment.

Since all magnetic poles of the rotor portion 20C according to the second modification are formed by the permanent magnets, the rotor portion 20C has an advantage such that vibration and noise are less likely to be generated, although the manufacturing cost of the rotor portion 20C is expensive as compared with the rotor portions 20 and 20A each having a consequent pole structure.

The first and second embodiments and the modifications described above can be combined as appropriate.

### (Water Heater)

Next, a description will be made of a water heater 100 as a refrigeration cycle apparatus to which the motor of any of the first and second embodiments and the modifications described above is applied.

FIG. 20 is a block diagram showing a circuit configuration of the water heater 100. The water heater 100 is also called a heat pump water heater. The water heater 100 includes a heat pump unit 110, a tank unit 120, and an operation unit 111 operated by a user.

The heat pump unit 110 includes a compressor 101, a refrigerant-water heat exchanger 102, a decompressor 103, an evaporator 104, a pressure detection device 105, a boiling-up temperature detector 108, a supply water temperature detector 109, an outside air temperature detector 117, a fan 107, a fan motor 106, and a heat pump unit controller 113.

The compressor 101, a refrigerant side of the refrigerant-water heat exchanger 102, the decompressor 103, and the evaporator 104 are connected by a refrigerant pipe 115 to configure a refrigerant circuit.

The compressor 101 is, for example, a rotary compressor, a scroll compressor, a vane compressor or the like, and compresses a refrigerant. The refrigerant-water heat exchanger 102 as a heat exchanger performs heat exchange between the refrigerant sent from the compressor 101 and water flowing through a hot water circulation pipe 116 (described later). The decompressor 103 decompresses the high-pressure refrigerant from the refrigerant-water heat exchanger 102. The evaporator 104 evaporates the low-pressure two-phase refrigerant decompressed by the decompressor 103.

The fan 107 blows outside air to the evaporator 104. The fan motor 106 drives the fan 107. The pressure detection device 105 detects a discharge pressure of the compressor 101. The boiling-up temperature detector 108 detects a boiling-up temperature of the refrigerant-water heat exchanger 102. The supply water temperature detector 109 detects a supply water temperature of the refrigerant-water heat exchanger 102. The outside air temperature detector 117 detects an outside air temperature.

The heat pump unit controller 113 receives signals from the pressure detection device 105, the boiling-up temperature detector 108, the supply water temperature detector 109, and the outside air temperature detector 117, controls the rotation speed of the compressor 101, the opening degree of the decompressor 103, and the rotation speed of the fan motor 106, and transmits and receives signals to and from a tank unit controller 112 (described later).

The tank unit 120 includes a hot water tank 114, a bath water reheating heat exchanger 118, a bath water circulation device 119, the pump 1 serving as a hot water circulation device, a mixing valve 121, an in-tank water temperature detection device 122, a post-reheating water temperature detection device 123, a post-mixing water temperature detection device 124, and the tank unit controller 112.

The hot water tank 114, the mixing valve 121, the pump 1, and the water side of the refrigerant-water heat exchanger 102 are connected by the hot water circulation pipe 116 to configure a water circuit. The pump 1 is disposed between the refrigerant-water heat exchanger 102 and the hot water tank 114 and circulates water in the hot water circulation pipe 116. The hot water tank 114 and the mixing valve 121 are connected by a bath water reheating pipe 125. The bath water reheating heat exchanger 118 and a bathtub are connected by a bath water pipe 126. The bath water circulation device 119 circulates bath water in the bath water pipe 126.

The hot water tank 114 stores therein hot water heated by heat exchange with a high-temperature and high-pressure refrigerant in the refrigerant-water heat exchanger 102. The bath water reheating heat exchanger 118 performs heat exchange between the hot water flowing through the bath water reheating pipe 125 and the bath water flowing through the bath water pipe 126. The mixing valve 121 is connected to the hot water circulation pipe 116, the hot water tank 114, and the bath water reheating pipe 125.

The in-tank water temperature detection device 122 detects a water temperature in the hot water tank 114. The post-reheating water temperature detection device 123 detects a temperature of water after passing through the bath water reheating heat exchanger 118. The post-mixing water temperature detection device 124 detects a temperature of water after passing through the mixing valve 121.

The tank unit controller 112 receives signals from the in-tank water temperature detection device 122, the post-reheating water temperature detection device 123, and the post-mixing water temperature detection device 124, controls the rotation speed of the pump 1 and opening and closing of the mixing valve 121, and transmits and receives signals to and from the operation unit 111. Although the tank unit controller 112 is shown as being provided inside the hot water tank 114 in FIG. 20, the tank unit controller 112 is actually provided outside the hot water tank 114.

The operation unit 111 is, for example, a remote controller, an operation panel, or the like including a switch, and allows a user to set a temperature of hot water, give an instruction of outputting hot water, and the like.

A boiling-up operation of the water heater 100 is described below. When the heat pump unit controller 113 receives a boiling-up operation instruction from the operation unit 111 or the tank unit controller 112, the heat pump unit controller 113 controls the compressor 101, the decompressor 103, the fan motor 106, and the like to carry out the boiling-up operation.

Specifically, the heat pump unit controller 113 controls the rotation speed of the compressor 101, the opening degree of the decompressor 103, and the rotation speed of the fan motor 106 based on detection values of the pressure detection device 105, the boiling-up temperature detector 108, the supply water temperature detector 109, and the outside air temperature detector 117 and information from the operation unit 111 transmitted from the tank unit controller 112.

Further, the detection value of the boiling-up temperature detector 108 is transmitted and received between the heat pump unit controller 113 and the tank unit controller 112. The tank unit controller 112 controls the rotation speed of the pump 1 in such a manner that the temperature detected by the boiling-up temperature detector 108 reaches a target boiling-up temperature.

A high-temperature and high-pressure refrigerant discharged from the compressor 101 is deprived of heat by water flowing through the hot water circulation pipe 116 by heat exchange in the refrigerant-water heat exchanger 102, and becomes a high-pressure and low-temperature refrigerant. The high-pressure and low-temperature refrigerant passing through the refrigerant-water heat exchanger 102 is decompressed by the decompressor 103. The refrigerant passing through the decompressor 103 flows into the evaporator 104 and is vaporized by taking heat of the outside air. The low-pressure refrigerant passing through the evaporator 104 is compressed again by the compressor 101 and discharged therefrom.

Meanwhile, water in a lower portion of the hot water tank 114 is sent to the refrigerant-water heat exchanger 102 by the pump 1 serving as a hot water circulation device. The water is heated by heat from the refrigerant in the refrigerant-water heat exchanger 102. The heated water (hot water) is returned to an upper portion of the hot water tank 114 through the hot water circulation pipe 116 and stored therein.

### (Refrigeration Cycle Apparatus)

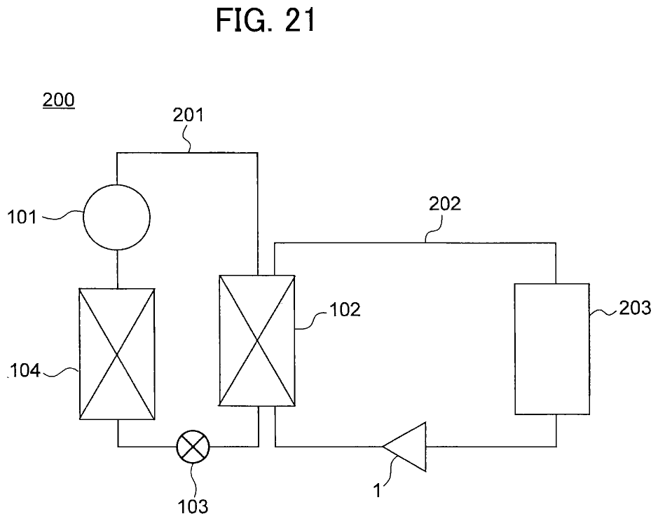

FIG. 21 is a block diagram showing a configuration of a refrigeration cycle apparatus 200 using the refrigerant-water heat exchanger 102. The water heater 100 described with reference to FIG. 20 is an example of the refrigeration cycle apparatus 200 using the refrigerant-water heat exchanger 102.

The refrigeration cycle apparatus 200 using the refrigerant-water heat exchanger 102 is, for example, an air conditioning apparatus, a floor heating apparatus, a water heater or the like. The pump 1 described in each of the first and second embodiments and the modifications is used in a water circuit 202 of the refrigeration cycle apparatus 200, and circulates water cooled or heated by the refrigerant-water heat exchanger 102 within the water circuit 202.

As shown in FIG. 21, a refrigerant circuit 201 of the refrigeration cycle apparatus 200 includes the compressor 101, the refrigerant-water heat exchanger 102, the decompressor 103, and the evaporator 104. The water circuit 202 of the refrigeration cycle apparatus 200 includes the pump 1, the refrigerant-water heat exchanger 102, and a load 203. That is, the refrigerant circuit 201 and the water circuit 202 are connected to each other by the refrigerant-water heat exchanger 102, and heat exchange is performed.

By applying the pump 1 equipped with the rotor 10 described in each of the first and second embodiments and the modifications to the refrigeration cycle apparatus 200 using the refrigerant-water heat exchanger 102, the manufacturing cost of the refrigeration cycle apparatus 200 can be reduced, and the operation efficiency can be improved.

Although preferred embodiments have been specifically described above, the present disclosure is not limited to the above-described embodiments, and various improvements or modifications can be made.

1. A rotor for a pump, the rotor comprising:
a rotor core having a magnet insertion hole and having an annular shape about an axis;
a permanent magnet inserted in the magnet insertion hole;
a rotor cover surrounding the rotor core from outside in a radial direction about the axis,
wherein the rotor core has:
a first core portion disposed on an inner side of the magnet insertion hole in the radial direction;
a second core portion disposed on an outer side of the magnet insertion hole in the radial direction; and
a hole separating the first core portion and the second core portion from each other, and
wherein the rotor cover has an end surface portion in contact with an end surface of the rotor core in a direction of the axis, and
wherein the end surface portion has a concave portion that engages with the second core portion,
wherein the first core portion and the second core portion are positioned in a circumferential direction about the axis by engagement between the concave portion and the second core portion.

2. The rotor according to claim 1, wherein the rotor cover has a convex portion that engages with the hole,
wherein the first core portion and the second core portion are positioned in the circumferential direction by engagement between the concave portion and the hole.

3. The rotor according to claim 2, wherein the rotor cover has a cylindrical wall portion surrounding the rotor core, and
wherein the convex portion protrudes inward from the wall portion in the radial direction.

4-5. (canceled)

6. The rotor according to claim 1, wherein the end surface portion is a first end surface portion, and
wherein the rotor cover has a second end surface portion facing the first end surface portion in the direction of the axis.

7. The rotor according to claim 1, wherein the rotor cover is made of a non-magnetic metal.

8. The rotor according to claim 1, wherein the rotor cover is made of a resin.

9. The rotor according to claim 1, further comprising a resin portion to hold the rotor core, the permanent magnet, and the rotor cover.

10. The rotor according to claim 9, further comprising a sleeve bearing on an inner side of the rotor core in the radial direction,
wherein the resin portion holds the sleeve bearing together with the rotor core, the permanent magnet, and the rotor cover.

11. The rotor according to claim 1, wherein the permanent magnet is a rare earth sintered magnet.

12. The rotor according to claim 1, wherein the permanent magnet is a bond magnet.

13. The rotor according to claim 1, wherein the permanent magnet constitutes a magnet magnetic pole, and
wherein a portion of the rotor core, which is adjacent to the permanent magnet in the circumferential direction, constitutes a virtual magnetic pole.

14. A motor comprising:
the rotor according to claim 1;
a stator surrounding the rotor from outside in the radial direction; and
a cup-shaped partitioning portion disposed between the rotor and the stator in the radial direction.

15. A pump comprising:
the rotor according to claim 1, the rotor having an impeller; and
a pump portion having a casing surrounding the impeller.

16. A refrigeration cycle apparatus comprising:
a heat exchanger connected to a refrigerant circuit and a water circuit; and
the pump according to claim 15, the pump circulating water in the water circuit.

17. A manufacturing method of a rotor for a pump; the manufacturing method comprising the steps of:
preparing a rotor core having a magnet insertion hole and having an annular shape about an axis;
inserting a permanent magnet into the magnet insertion hole; and
attaching a rotor cover to an outer side of the rotor core in a radial direction about the axis,
wherein the rotor core has a first core portion disposed on an inner side of the magnet insertion hole in the radial direction, a second core portion disposed on an outer side of the magnet insertion hole in the radial direction, and a hole separating the first core portion and the second core portion from each other, and
wherein the rotor cover has an end surface portion in contact with one end surface of the rotor core in a direction of the axis, and
wherein the end surface portion has a concave portion that engages with the second core portion,
wherein the first core portion and the second core portion are positioned in a circumferential direction about the axis by engagement between the concave portion and the second core portion.

18. The manufacturing method according to claim 17, further comprising the step of integrally molding the rotor core, the permanent magnet, and the rotor cover with a resin.
